(19) United States
(12) Patent Application Publication
(10) Pub. No.: US 2008/0034971 A1
(43) Pub. Date: Feb. 14, 2008

(54) Air filter

(76) Inventor: Daryl McIntosh, Coral Springs, FL (US)

Correspondence Address: Charles E. Temko, Esq., 22 Marion Road, Westport, CT, 06880, US

(21) Appl. No.: 11/502,573

(22) Filed: Aug. 11, 2006

(51) Int. Cl. B01D 46/00

(52) U.S. Cl. 95/273; 96/226; 55/524; 55/485; 55/486

(57) ABSTRACT

An improved air-conditioner filter, including a planar element for entrapping dust particles, and an additional planar porous element impregnated with a bacteriostat, the filter being arranged in an air-handler unit such that inducted air is first filtered for dust, and subsequently treated for remaining micro-sized organic material. A frame element peripherally encloses the element for entrapping dust particles and the additional porous element so that the components of the filter may be readily replaced as a unit.

### RELATED APPLICATION

Reference is made to my copending provisional application for letters patent, Ser. No. 60/15,789, filed Aug. 14, 2005 to which a claim of priority is made.

### BACKGROUND OF THE INVENTION

This invention relates generally to the field of air filters of a type used in air-conditioning systems, and more particularly to an improved type particularly suited for use in tropical environments, which present-problems in addition to the usual filtration of dust particles.

In systems installed in such areas, it is common to experience the clogging of drains which conduct condensate accumulated on the cooling coils of the associated air-handler unit. This is primarily due to the growth of algae, fungus, and mold which over relatively short periods of time expand in volume to completely block the passage of condensate liquid necessitating the blowing out of the accumulation using a compressed inert gas, such as nitrogen.

This condition has been relatively recently improved by the use of small tablets periodically placed in the drain tray containing soluble bacteriostat, but manual access to the drain tray is usually not as simple as replacement of an air filter, and is difficult, depending upon positioning of the air handler, particularly by older persons.

The use of a replaceable air filter is well known in the art. Such filters usually include a fibrous outer frame which encloses a perforated semi-rigid screen which supports a fiberglass filter in planar condition. When the fiberglass filter has accumulated a sufficient amount of dust particles, it reduces air flow therethrough, and the entire device is replaced with a new filter which fits in a corresponding recess in the air handler. However, the operation of the filter does not discourage the growth of algae, fungus, or mold which are too small to be trapped by the fiberglass filter.

There thus arises a need for an improved replaceable filter which will both filter dust particles, and a biostatic element which will at least substantially reduce the transmission of substances which ultimately impede condensate drainage. There is also a need for providing an antistatic capability to prevent the accumulation of particles in the pores of the biostatic element.

The problem with coping with mold, bacteria, algae, and other small particles has been recognized in the art, as exemplified by U.S. patent to Rosen, U.S. Pat. No. 5,525,136 where a custom filter is disclosed which accommodates an electrostatic filter which must be removed and cleaned with soap and water before replacement, and a fibrous filter which is discarded and replaced separately, each time the filter is serviced. In addition, a metallic custom built frame of relatively rigid material is required, tending to make the filter expensive, both to manufacture, and burdensome to service.

It is therefore a principal object of the present invention to provide an improved filter of the type described which may be manufactured at relatively modest cost including a biostatic element in which all components thereof may be simultaneously replaced by users having only ordinary skill.

### SUMMARY OF THE INVENTION

Briefly stated, the invention contemplates the provision of an improved replaceable air-conditioning filter of the type above-described, in which provision has been incorporated for destroying and preventing the growth of algae, fungus, and mold, to a degree that it will normally be sufficient to merely periodically replace the filter without having to access other components of the air handler. To this end, the filter incorporates in addition to a conventional fiberglass or polyester filter, a synthetic resinous foam material of polytetrafluoroethylene or similar polyester which has been impregnated with a known bacteriostat having chemical agents which are activated by passage of air through the filter so that the air passing not only through the air handler, but the area enclosed and serviced by the air-conditioner will be as clean as possible. Because of the anti-static qualities of the foam material, the micro-sized particles do not become lodged in the foam layer. The enclosing frame is made of fibrous or metallic material, and all of the filter layers are enclosed by the frame, so that the entire filter may be removed and replaced as a simple operation.

### BRIEF DESCRIPTION OF THE DRAWINGS

In the drawings, to which reference will be made in the specification, similar reference characters have been employed to designate corresponding parts throughout the several views.

FIG. 1 is a view in elevation of an embodiment of the invention.

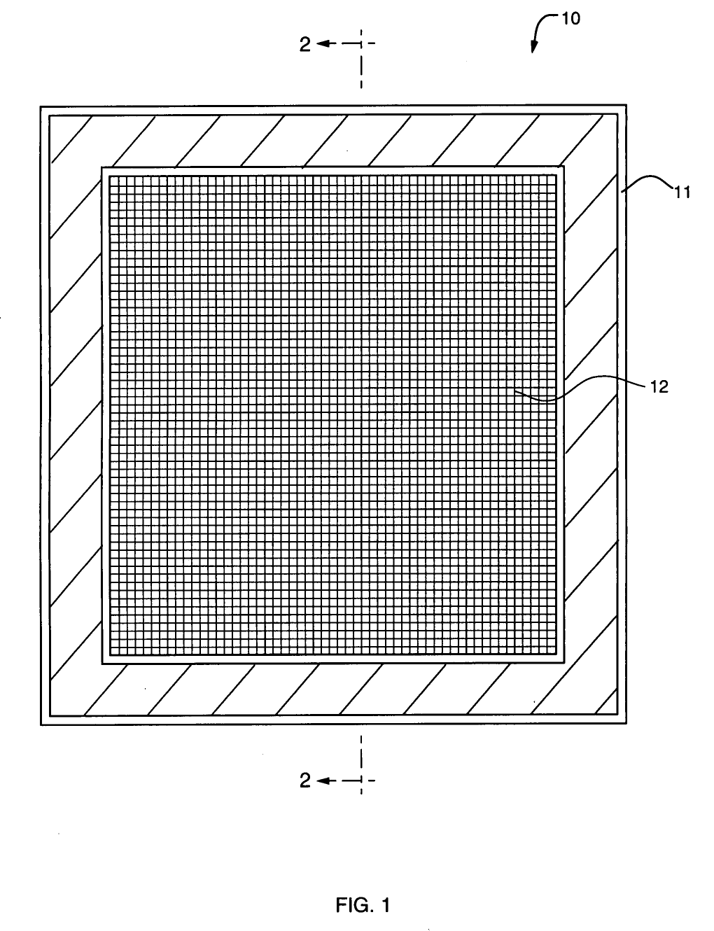

FIG. 2 is a central sectional view thereof as seen from the plane 2-2 in FIG. 2.

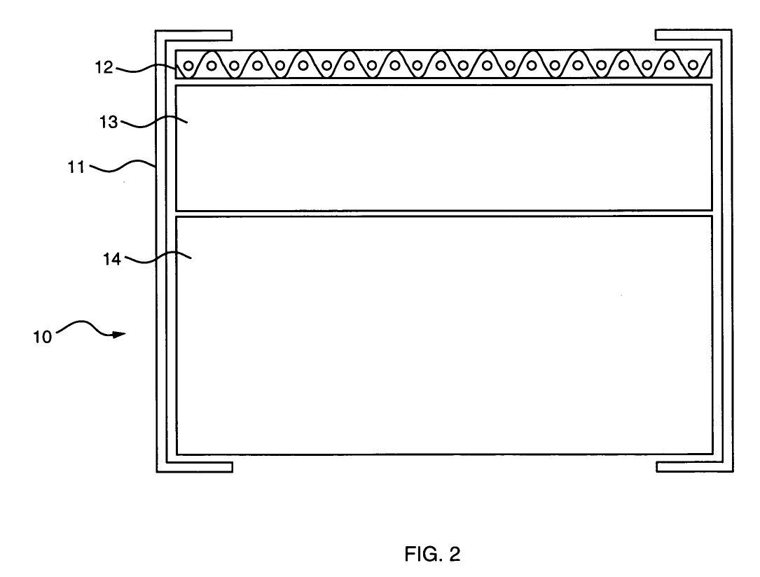

FIG. 3 is a graph illustrating the entrapping of particles relative to removal efficiency.

### DETAILED DESCRIPTION OF THE DISCLOSED EMBODIMENT

In accordance with the invention, the device, generally indicated by reference character 10, comprises broadly a frame element 11 of fibrous material, a screen element 12, an open pore synthetic resinous biostatic element 13, and a dust filler element 14, typically of fiberglass or polytetrafluoroethylene.

The frame element 11, screen element 12, and fiberglass element 13 may be of types well known in the art, and are manufactured using known techniques.

The screen element 12 may be of any desired material, and is preferably of synthetic resinous material so as to be readily heat sealed to the biostatic element to add rigidity to the same.

The biostatic element 13 is preferably in the form of a porous membrane which is available in a variety of pore-sizes and thickness under the trademark Donaldson Tetratex, and available from Donaldson Company, Inc. of Minneapolis, Minn. For a typically sized screen having dimensions 25″×25″, a suitable thickness varies from 10 mils to one inch, with a porosity of 80-90% and pore size ranging from 7-10 microns. The membrane is impregnated to maximum capacity with a microbiostat solution such as BBJ microbiocide available from BBJ Environmental Solutions, Inc., of Tampa, Fla. This product is known for use in air-conditioning systems, and is used as a coating spray deposited upon cooling coils, drain pans, and other components of air-conditioning air handlers. However, such applications are not readily performed without technical assistance because of difficulty of access to these components.

In accordance with the present invention, the product is applied at maximum sprayable concentration with a compressed air sprayer or fogging device directly to the biostatic element 13 after manufacturing assembly of the filter to obtain maximum absorption capacity. It may also be applied at an earlier stage depending upon particular manufacturing techniques. This coating will evaporate within the pores, and provide an effective bacteriostat coating normally lasting six months, which contacts air passing through the filter. The air has previously passed through the dust element 14 which removes larger dust particles, so that air circulated from the air handler is essentially uncontaminated air. It is noted that the biostatic element 13, which is made of polyester materials is inherently anti-static to effectively resist any tendency for micro-sized particles to become lodged in the pores of the biostatic element.

The dust filter element 14 may be of known type of polyester or fiberglass fibers, and will entrap larger, normally non-biotic particles as air passes therethrough.

With normal usage, both the biostatic element and the dust filter element 14 will lose efficiency as dust particles are accumulated, and the entire filter device 10 including biostatic element 13 is replaced as a unit.

It is noted that the frame element includes both side walls 15 and end walls 16, which are glued or otherwise secured to the screen element 12, and the peripheral exposed surface of the dust filter element 14, so that the entire device is replaced as a unit, normally at six month intervals when the biostatic element and dust filter element have both lost substantial efficiency.

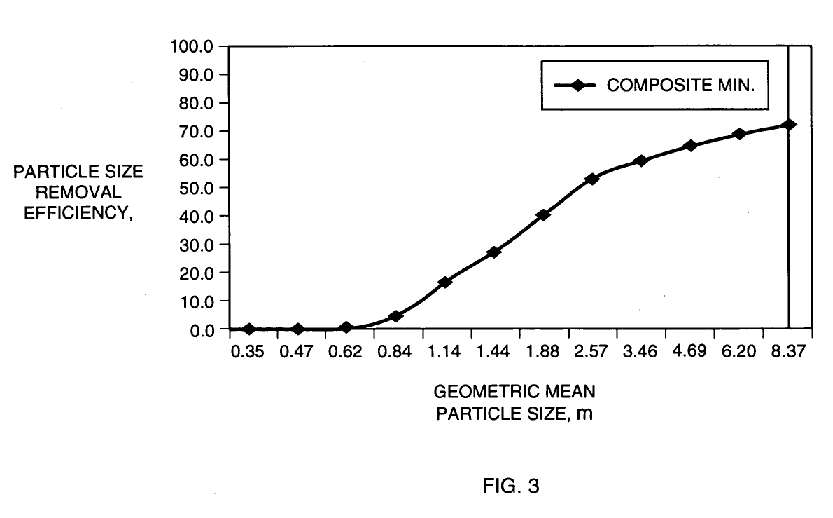

FIG. 3 illustrates the efficiency of a tested filter using a total filter thickness of one inch. Although bacteria normally range in size from 0.3 microns to as much as 4.0 microns, it will be noted that particles under 0.84 microns are not entrapped and will pass through the filter. Such particles are treated by the biostatic element which does not kill the bacteria but prevents it from reproducing. It is noted that filter efficiency rises with particle size, but with continuous circulation, the bulk of the larger particles above two microns are filtered.

It may thus be seen that I have invented novel and highly useful improvements in air-conditioning filter devices which will not only entrap dust particles during operation of the air-conditioner, but also include algae, fungus, and mold-inhibiting components to the circulated air to result in maintaining conduit drains, as well as cooling coils associated with the air-conditioning unit during extended periods of time and improve the quality of the circulated air to the related enclosed cooled space. The device may be manufactured at sufficiently low cost, that it may be replaced as a unit by those having only ordinary skills.

I wish it to be understood that I do not consider the invention to be limited to the details of structure illustrated and described in the specification, for obvious modifications will occur to those skilled in the art to which the invention pertains.

I claim:

1. In a replaceable air filter for an air-conditioning unit, including a fibrous outer frame element, a screen element, and a dust filter element, the peripheral edges of said screen unit and filter unit being secured to said frame element, the improvement comprising: a biostatic element of porous sponge-like planar material positioned between said screen element and said filter element, said biostatic element being coated with a biostatic material exposed to filtered air passing through said dust filter element; said entire frame element peripherally enclosing said screen element, biostatic element, and dust filter element.

2. The improvement in accordance with claim 1, said biostatic element being formed of porous polyester material, and having a thickness ranging from 10 mils to one inch, and a pore size ranging from 7 to 10 microns.

3. The method of maintaining air-conditioning condensate drain conduits in a system against blockage caused by the accumulation of organic material, comprising the steps of:
a) providing an in-line air filter having a synthetic foam filter element impregnated with a water soluble bacteriostat; and a dust filter element; and
b) positioning said filter such that air flows therethrough to first filter dust particles, and then flow through said foam filter element to destroy micro-sized organic material.
